(19) United States
(12) Patent Application Publication
(10) Pub. No.: US 2026/0009915 A1
(43) Pub. Date: Jan. 8, 2026

(54) METHODS AND COMPUTING SYSTEMS FOR IMPLEMENTING AMPLITUDE INVERSION

(71) Applicant: SCHLUMBERGER TECHNOLOGY CORPORATION, Sugar Land, TX (US)

(72) Inventors: Maud CAVALCA, Crawley (GB); Robin P. FLETCHER, Crawley (GB)

(21) Appl. No.: 19/127,753

(22) PCT Filed: Mar. 8, 2024
(86) PCT No.: PCT/US2024/019058

§ 371 Date: May 7, 2025

Related U.S. Application Data
(60) Provisional application No. 63/489,464, filed on Mar. 10, 2023.

(51) Int. Cl. G01V 1/28; G01V 1/30; G01V 1/34

(52) U.S. Cl. CPC G01V 1/282; G01V 1/306; G01V 1/345; G01V 2210/6242; G01V 2210/74

(57) ABSTRACT

Disclosed is a method comprising: receiving seismic data; generating PP-wave image angle gathers data and PS-wave image angle gathers data using the seismic data; generating PP-wave point spread function (PSF) angle gathers that serve as a first convolution input; generating PS-wave PSF angle gathers that serve as a second convolution input; generating PP-wave synthetic angle gathers data using the first convolution input and a first reflectivity operator, generating PS-wave synthetic angle gathers data using the second convolution input and a second reflectivity operator, generating first output data using the PP-wave angle gathers data and the PP-wave synthetic angle gathers data; generating second output data using the PS-wave image angle gathers data and the PS-wave synthetic angle gathers data; generating optimization data using the first output or the second output together with a parameter of a geological model; and updating, using the optimization data, an elastic property of the geological model.

### CROSS-REFERENCE TO RELATED APPLICATIONS

This application claims priority to U.S. Provisional Application No. 63/489,464, filed on Mar. 10, 2023, titled “Methods And Computing Systems For Implementing Amplitude Inversion,” which is incorporated herein by reference in its entirety for all purposes.

### TECHNICAL FIELD

The present disclosure relates to systems and methods for optimizing seismic data processing.

### BACKGROUND

While some techniques for amplitude inversion of seismic data suffice for reservoirs with simple geological properties, these approaches often are inadequate or sometimes inapplicable to complex geological configurations or models. In particular, there is a need to leverage analysis operations for converted seismic wave (e.g., PS wave) reflections in geological environments that include one or more complex geological variations.

### SUMMARY

Disclosed are methods, systems, and computer programs that generate at least one elastic property associated with a geological model. According to an embodiment, a method for generating at least one elastic property associated with a geological model comprises: receiving seismic data captured by one or more sensors associated with a resource site; extracting PP-wave and PS-wave data comprised in the seismic data; applying a first imaging process to the extracted PP-wave and PS-wave data and thereby generate PP-wave image angle gathers data and PS-wave image angle gathers data, respectively; applying a second imaging process to PP-wave demigration data derived from a first set of point scatterers associated with the resource site and thereby generate PP-wave point spread function (PSF) angle gathers that are useable as a first convolution input; and applying a third imaging process to PS-wave demigration data derived from a second set of point scatterers associated with the resource site and thereby generate PS-wave point spread function (PSF) angle gathers that are useable as a second convolution input.

The method according to some implementations further comprises: convolving the first convolution input with a first reflectivity operator and thereby generate PP-wave synthetic angle gathers data; convolving the second convolution input with a second reflectivity operator and thereby generate PS-wave synthetic angle gathers data; comparing the PP-wave image angle gathers data with the PP-wave synthetic angle gathers data and thereby generate first output data; comparing the PS-wave image angle gathers data with the PS-wave synthetic angle gathers data and thereby generate second output data; combining one or more of the first output data and the second output data with at least one parameter associated with a geological model of the resource site and thereby generate optimization data; updating, based on the optimization data, at least one elastic property associated with the geological model of the resource site; determining steady state or final values of the at least one elastic property associated with the geological model of the resource site; and generating a report indicating the steady state or final values of the at least one elastic property on a graphical display device . . .

In other embodiments, a system and a computer program can include or execute the method described above. These and other implementations may each optionally include one or more of the following features.

The first imaging process or the second imaging process or the third imaging process comprises a ray-based depth migration process. Furthermore, at least the first imaging process comprises creating seismic images collected by a reflection angle at a point of reflection of a propagated seismic wavefield associated with the seismic data.

According to some embodiments, convolving the first convolution input with the first reflectivity operator and thereby generate PP-wave synthetic angle gathers data comprises executing a 3-dimensional spatial convolution operation. Furthermore, convolving the second convolution input with the second reflectivity operator and thereby generate PS-wave synthetic angle gathers data comprises executing a 3-dimensional spatial convolution operation.

In exemplary implementations, the PS-wave PSFs are generated by computing kinematic or dynamic PS-wave ray attribute data including travel time data, slowness vector data, energy level data for each seismic source and receiver pair associated with a dataset geometry comprised in the seismic data.

Moreover, the PS-wave ray attribute data may be generated by combining: P-wave ray attribute data derived from P-wave ray tracing between a seismic source and a point scatterer; and S-wave ray attribute data derived from S-wave ray tracing between the receiver and the point scatterer. According to some embodiments, the P-wave ray attribute data and the S-wave ray attribute data, in combination, are applied to generate the dynamic PS-wave ray attribute data while the dynamic PS-wave ray attribute data together with geological attribute data related to a ray-based depth migration process are used to generate the PS-wave PSFs.

According to some embodiments, one or more of the first reflectivity operator and the second reflectivity operator are derived from elastic properties data of a prior geological model associated with the resource site.

It is appreciated that the report discussed in conjunction with flowchart 1300 may be used for at least one of: well placement operations at the resource site; equipment placement operations at the resource site; and surgically locating a subsurface resource at the resource site. In particular, the report, according to some embodiments, comprises one or more of a multi-dimensional visualization comprising image or textual data associated with the geological model. Furthermore, the report may be adapted for use in energy development operations including at least one of: well placement operations at the resource site; equipment placement operations at the resource site; surgically locating a subsurface resource at the resource site; carbon storage operations at the resource site; configuring at least one equipment associated with the energy development operations at the resource site; and implementing safety protocols associated with the energy development operations at the resource site.

It is further appreciated that the first set of point scatterers associated with the resource site and the second set of point scatterers associated with the resource site are the same set of point scatters associated with the resource site.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1A depicts an exemplary computing or network system within which the disclosed methods, systems, and computer programs can be implemented according with some embodiments of this disclosure.

FIGS. 1B-1F illustrate exemplary schematic views of a resource site for which gas storage capacities may be determined according to some embodiments of this disclosure.

FIG. 1G illustrates a resource site for performing production operations in accordance with implementations of various technologies and techniques described herein.

FIG. 1H illustrates a side view of a marine-based survey of a subterranean subsurface in accordance with one or more implementations of various techniques described herein.

FIG. 1I depicts a marine electromagnetic survey system in accordance with some implementations of this disclosure.

FIG. 2 shows a first exemplary workflow for generating elastic property data associated with a geological or earth model.

FIG. 3 shows a second exemplary workflow for generating PS-wave point spread functions (PSFs).

FIG. 4 shows S-wave velocity data, P-wave velocity data, and density data associated with a resource site.

FIG. 5 shows PS-wave Kirchhoff depth-migrated images for three angle ranges.

FIG. 6 shows PS-wave synthetic images for three angle ranges.

FIG. 7 provides a schematic of the imprint of PP-wave and PS-wave illumination induced by the data decimation process, for a given angle.

FIGS. 8A and 8B shows the expected PS-wave reflectivity, determined analytically, for two contrasts.

FIGS. 9A, 9B, 9C, and 9D display a comparison of the amplitude-versus-angle (AVA) responses extracted from PS-wave Kirchhoff depth-migrated images and extracted from PS-wave synthetic images.

FIG. 10 depicts an illustration directed to an inverted Vp/Vs geological model.

FIGS. 11A and 11B show inverted Vp/Vs depth profile data associated with FIG. 10.

FIGS. 12A and 12B display a comparison of the PS-wave Kirchhoff depth-migrated data and of the inverted PS-wave reflectivity data, for five angle ranges.

FIG. 13 provides an exemplary detailed workflow for methods, systems, and computer programs that generate at least one elastic property associated with a geological model of a resource site.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the disclosed technology. However, it will be apparent to one of ordinary skill in the art that the disclosed embodiments may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the disclosure. The first object or step, and the second object or step, are both objects or steps, respectively, but they are not to be considered the same object or step.

The terminology used in the description of the disclosed techniques is for the purpose of describing particular embodiments and is not intended to be limiting. As used in the description of this disclosure and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Overview

Seismic surveying can include the process of recording reflected seismic waves from beneath the subsurface in order to model geological structures and physical properties of the earth. For instance, the aim of a seismic survey may be to depict or otherwise model physical properties of a reservoir or other subterranean structures. To more clearly contextualize the disclosed solution, the following nomenclature would be applied to some embodiments of this disclosure:
P-wave: primary or pressure or compressional waves.
S-wave: secondary or shear waves.
SV-mode: this mode characterizes a S-wave polarized vertically.
PP-wave: these waves indicate a reflection of a P-wave leaving a source downward.
PS-wave: these indicate a P-wave reflected as an S-wave (converted wave).

While some seismic techniques are applied to collecting seismic survey data, such techniques are often deficient in processing seismic survey data to form reliable and/or accurate images of the subsurface. Accordingly, there is a need for methods and computing systems that can employ effective, optimal, and accurate processes for identifying, isolating, transforming, and/or processing various aspects of seismic survey data/signals or other collected data associated with a subsurface region or associated with a multi-dimensional model generated based on subsurface data.

Furthermore, the disclosed solution leverages converted (PS) reflections to implement a joint inversion scheme that enables simultaneous PP and PS amplitude inversion processes while mitigating illumination effects associated with PP-waves and PS-waves. According to some embodiments, the disclosed process includes deriving one or more point spread functions (PSFs) that relate to the PS-waves of the seismic system and capture the illumination effects present in depth-migrated images of PS-wave recorded data, which can differ from the illumination effects present in images of PP-wave recorded data. In addition, the disclosed process applies an extended inversion formulation that incorporates both PP and PS reflectivity operators to derive underlying earth elastic properties of a subsurface with reduced bias-data associated with the PP-wave and PS-wave illumination effects. In other embodiments, the PSFs associated with the PP-waves and PS-waves can be used to compensate PP-wave images and PS-wave images for wavelet effects and/or illumination effects, respectively. In such cases, a least-squares migration scheme can be used for deriving the PP-wave reflectivity and PS-wave reflectivity, simultaneously or through independent schemes. The derived PP-wave reflectivity and PS-reflectivity can be used jointly or disjointly for structural interpretation of subterranean formations and/or used in a PP-PS simultaneous amplitude inversion scheme to derive underlying earth elastic properties of a subsurface with reduced bias-data associated with the PP-wave and PS-wave illumination effects.

### Computing Systems

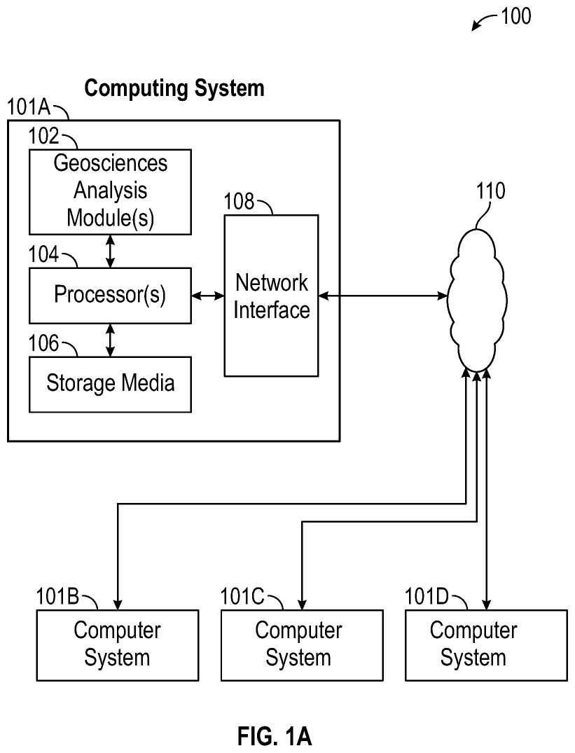

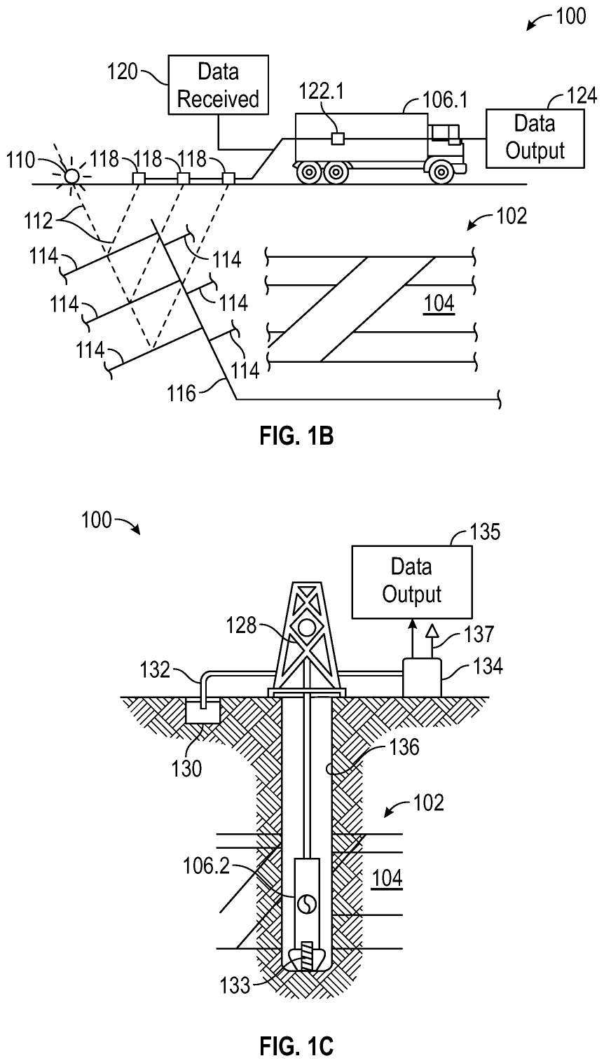

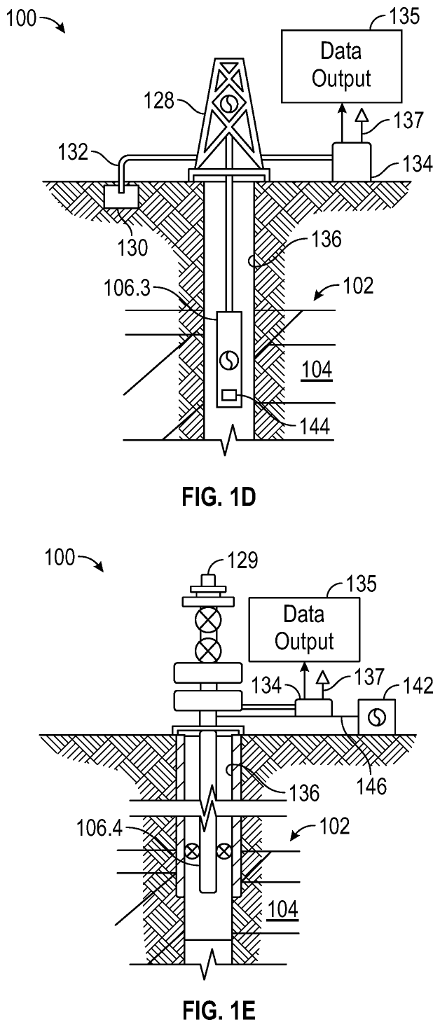

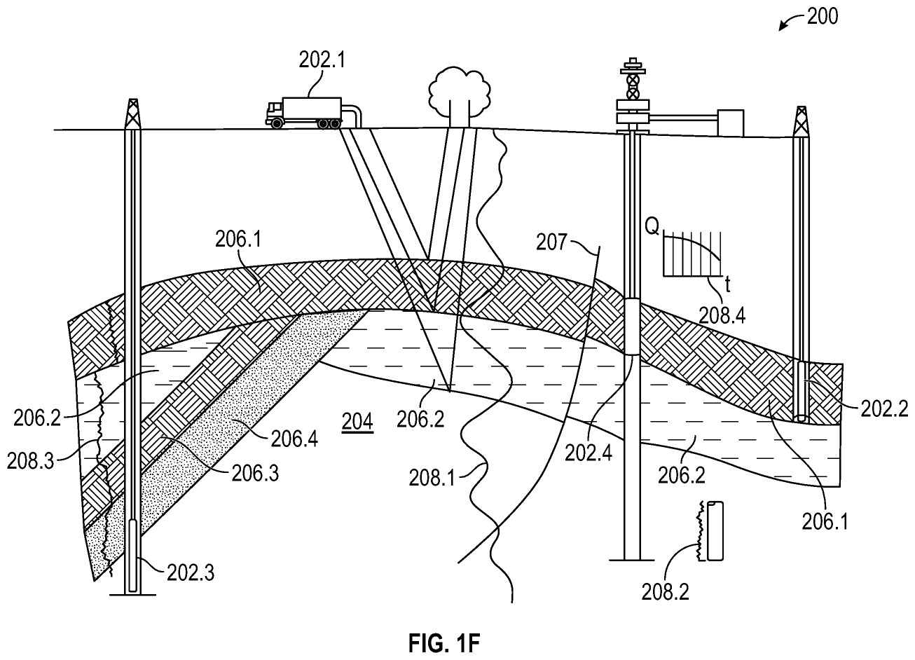

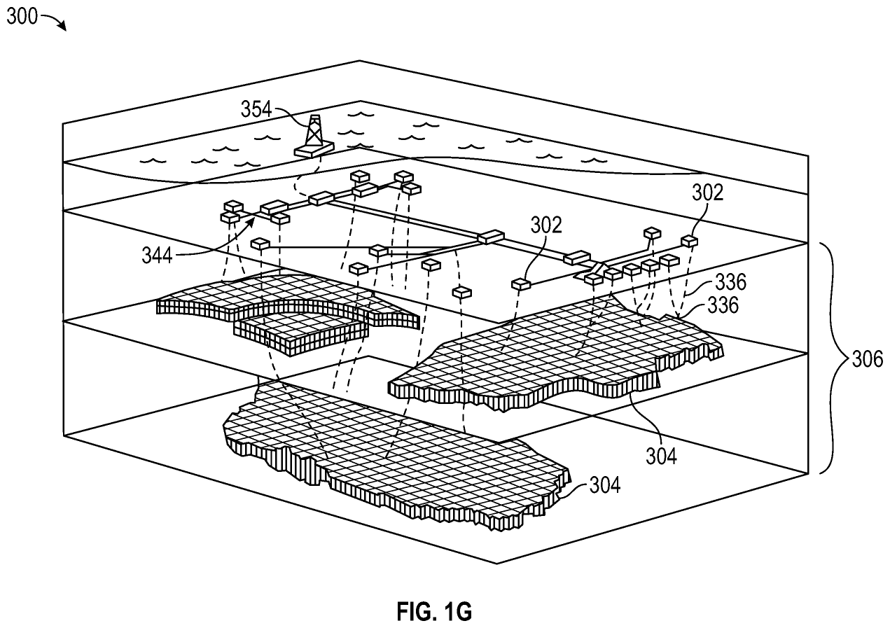

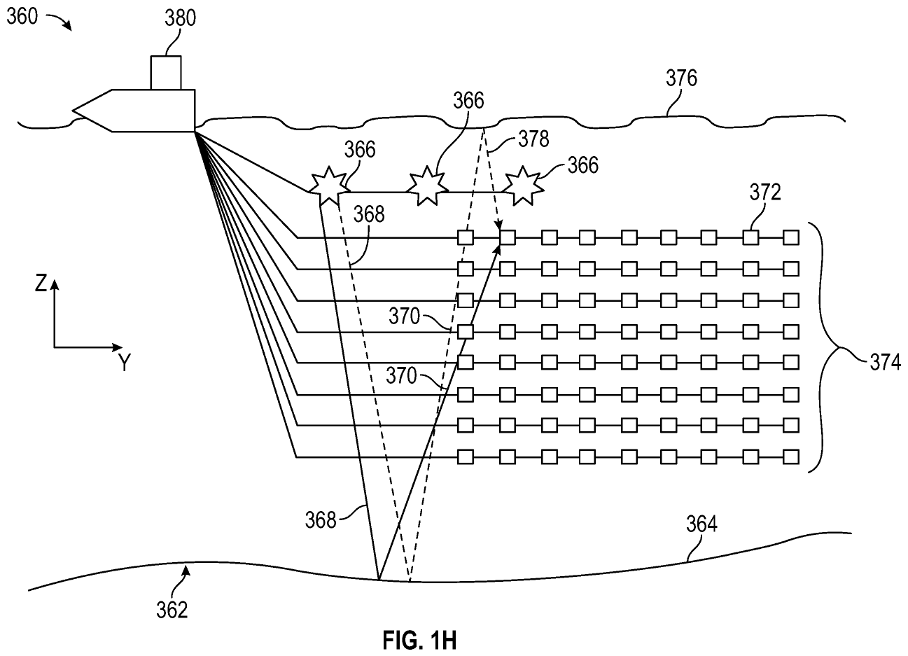

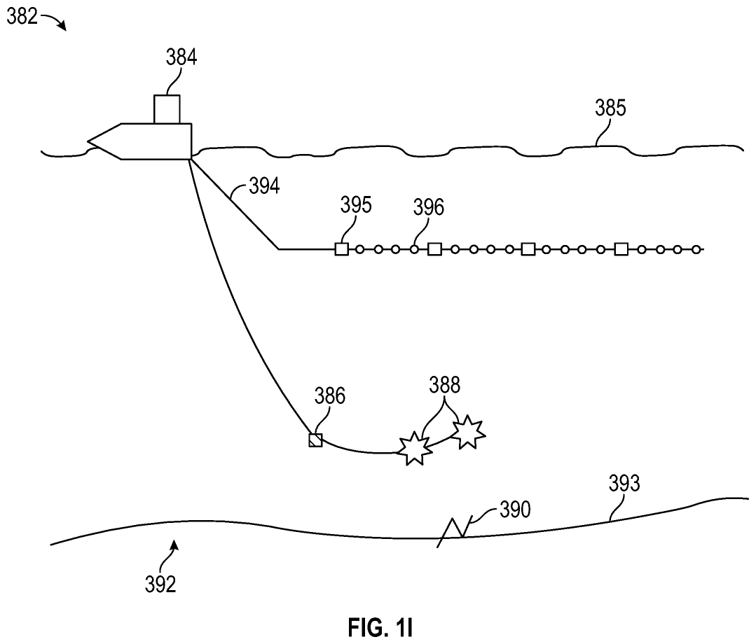

FIG. 1A depicts an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, the geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations relative to each other or to computer system 101A. For example, computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network and may use portions of public networks and may include local or remote storage and/or application processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1A storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media can be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It is appreciated that computer system 101A is one example of a computing system, and that computer system 101A may have more or fewer components than those shown and may combine additional components not depicted in the example embodiment of FIG. 1A, and/or computer system 101A may have a different configuration or arrangement of components relative to the components depicted in FIG. 1A. The various components shown in FIG. 1A may be implemented in hardware, software, or a combination of both, hardware and software, including one or more signal processing and/or application specific integrated circuits.

It is appreciated that while no user input/output peripherals are illustrated with respect to computer systems 101A, 101B, 101C, and 101D, many embodiments of computing system 100 include computer systems with keyboards, mice, touch screens, displays, and other user peripheral systems or other input-output systems. Some computer systems in use in computing system 100 may be desktop workstations, laptops, tablet computers, smartphones, server computers, etc.

Further, the steps in the processing methods described herein may be implemented by running one or more functional modules in an information processing apparatus such as general purpose processors or application specific chips, such as ASICs, FPGAs, PLDs, or other appropriate devices. These modules, combinations of these modules, and/or their combination with general hardware are included within the scope of protection of the disclosed subject-matter.

FIGS. 1B-1E illustrate exemplary schematic views of a resource site (e.g., an oilfield 100) having subterranean formation 102 containing reservoir 104 therein in accordance with implementations of various technologies and techniques described herein. FIG. 1B illustrates a survey operation being performed by a survey tool, such as seismic truck 106.1, to measure properties of the subterranean formation. The survey operation is a seismic survey operation for producing sound vibrations. In FIG. 1B, one such sound vibration, e.g., sound vibration 112 is generated by source 110 such that the sound vibration reflects off horizons 114 in the earth formation 116. A set of sound vibrations may be received by sensors (e.g., geophone-receivers 118) situated on the earth's surface. The data received 120 may be provided as input data to a computer 122.1 of a seismic truck 106.1, and responsive to the input data, computer 122.1 may generate seismic data output 124. This seismic data output may be stored, transmitted or further processed as the case may require.

FIG. 1C illustrates a drilling operation being performed by drilling tools 106.2 suspended by rig 128 and advanced into subterranean formations 102 to form wellbore 136. Mud pit 130 may be used to draw drilling mud into the drilling tools via flow line 132 to circulate drilling mud down to the drilling tools, then up the wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging systems while drilling. The logging systems may also be adapted for taking core (e.g., soil) sample 133 as shown according to some embodiments.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors, such as gauges, may be positioned about oilfield 100 to collect data relating to various oilfield operations as described previously. In some embodiments, a sensor may be positioned in one or more locations around the drilling tools and/or at rig 128 to measure drilling parameters, such as weight on bit, torque on bit, pressures, temperatures, flow rates, compositions, rotary speed, and/or other parameters of the field operation. The sensors may also be positioned at one or more locations in the circulating system according to some embodiments.

Drilling tools 106.2 may include a bottom hole assembly (BHA) (not shown), near the drill bit (e.g., within several drill collar lengths from the drill bit). The bottom hole assembly may also include capabilities for measuring, processing, and storing information, as well as communicating with surface unit 134. The bottom hole assembly may further include drill collars for performing various other measurement functions.

The bottom hole assembly may include a communication subassembly that communicates with surface unit 134. The communication subassembly may be adapted to send signals to and receive signals from the surface using a communications channel such as mud pulse telemetry, electro-magnetic telemetry, wireless technology, or a wired drill pipe communications system. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other telemetry systems.

According to some embodiments, the wellbore may be drilled according to a drilling plan that is established prior to drilling. The drilling plan may set forth equipment data, pressure data, trajectory information and/or other data parameters that define or otherwise specify the drilling process for a given wellsite associated with the resource site (e.g., oilfield 100). The drilling operation may then be performed according to the drilling plan. However, as information is gathered, the drilling operation may be optimized or updated to, for example, deviate from the drilling plan to satisfy efficient drilling operations. Additionally, as drilling or other operations are performed, the subsurface conditions may change. An earth model associated with the resource site may also updated or adjusted to account for the new information being collected about the resource site.

The data gathered by the sensors disposed about the resource site may be received by surface unit 134 and/or other data collection sources for analysis or other processing. The data collected by the sensors may be used alone or in combination with other data. The data may be received by, and/or stored in one or more databases and/or transmitted to an onsite location or an offsite as the case may require. The data may be historical data, real time data, or combinations thereof. The real time data may be used in real time operations or stored for later use. The real-time data may also be combined with historical data or other inputs for further analysis. According to some embodiments, the data collected at the resource site may be stored in separate databases or combined within a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1D illustrates a wireline operation being performed using wireline tool 106.3 suspended by rig 128 and into wellbore 136 of FIG. 1C. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1B. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors, such as gauges, may be positioned about the resource site (e.g., oilfield 100) to collect data relating to various field operations as described previously. According to some embodiments, the sensor may be positioned within wireline tool 106.3 to measure downhole parameters which relate to, for example porosity, permeability, fluid composition and/or other parameters of the field operation.

FIG. 1E illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146. According to some embodiments, sensors, such as gauges, may be positioned about oilfield 100 to collect data relating to various field operations as described previously. For example, the sensors may be positioned within production tool 106.4 or within or about an associated equipment, such as Christmas tree 129, gathering network 146, surface facility 142, and/or the production facility, to measure fluid parameters, such as fluid composition, flow rates, pressures, temperatures, and/or other parameters of the production operation. In some embodiments, one or more injection wells may be fluidly coupled to the reservoir for added fluid recovery. Furthermore, one or more gathering facilities may be operatively connected to one or more of the wellsites within the resource site (e.g., oilfield 100) for selectively collecting downhole fluids from the wellsite(s).

While FIG. 1C-1E illustrate tools used to measure properties of a resource site (e.g., oilfield 100), it is appreciated that the tools may be used in connection with non- oilfield operations, such as gas fields, mineral mines, aquifers, storage, or other subterranean facilities. Also, while certain data acquisition tools are depicted, it is appreciated that various measurement tools capable of sensing parameters, such as seismic two-way travel time, density, resistivity, production rate, etc., of the subterranean formation and/or its geological formations may be used. Various sensors may be located at various positions along the wellbore and/or coupled to or be situated within the monitoring tools to collect and/or monitor the desired data. Other sources of data may also be provided from offsite locations to supplement or otherwise enhance data captured at the resource site.

The field configurations of FIGS. 1B-1E are intended to provide a brief description of an example of a resource site usable with oilfield application frameworks. Part of, or the entirety, of oilfield 100 may be on land, water, and/or sea. Also, while data associated with a single resource site is indicated as being measured and/or processed at a single location within these figures, oilfield applications may be used with any combination of one or more resource sites (e.g., a plurality of oilfields 100), one or more processing facilities, and one or more similar or dissimilar wellsites.

FIG. 1F illustrates a schematic view, and in particular, a partial cross section of the resource site (e.g., referenced as oilfield 200 in the figure) that has data acquisition tools 202.1, 202.2, 202.3 and 202.4 positioned at various locations about the resource site for collecting data of subterranean formation 204 in accordance with implementations of various technologies and techniques described herein. Data acquisition tools 202.1-202.4 may be the same as data acquisition tools 106.1-106.4 of FIGS. 1B-1E, respectively, or others not depicted. As shown, data acquisition tools 202.1-202.4 may generate data plots or measurements 208.1-208.4, respectively. These data plots are depicted along the resource site (e.g., oilfield 200) to demonstrate the data generated by the various operations.

Data plots 208.1-208.3 are examples of static data plots that may be generated by data acquisition tools 202.1-202.3, respectively; however, it is appreciated that data plots 208.1-208.3 may include data plots that are updated in real time or near-real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208. 1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that can provide, for example, a resistivity measurement or some other measurements of the formation at various depths. Also shown in the figure is a production decline curve or graph 208.4 which indicates a dynamic data plot of the fluid flow rate over time. The production decline curve can provide the production rate as a function of time. As fluid flows through the wellbore, measurements may be taken of fluid properties, such as flow rates, pressures, composition, etc., according to some embodiments.

According to some implementations, other data may also be collected or captured or associated with the resource site, such as historical data, user input data, economic data, and/or other sensor data and/or other parametric data associated with one or more models of the resource site. As described below, static and dynamic measurements may be analyzed and/or used to generate models of the subterranean formation to determine characteristics thereof. Similar or dissimilar measurements may also be used to measure or track changes a geological formation associated with the resource over time.

In some embodiments, the subterranean structure 204 may have a plurality of geological formations 206.1-206.4. As shown in FIG. 1F, this geological formations may comprise several formations or layers, including a shale layer 206.1, a carbonate layer 206.2, a shale layer 206.3 and a sand layer 206.4. A fault 207 may extend through the shale layer 206.1 and the carbonate layer 206.2. In addition, the static data acquisition tools may be adapted to take measurements and detect characteristics of the aforementioned formations and/or other geological structures within the subterranean structure 204. While a specific subterranean formation with specific geological structures is depicted FIG. 1F, it is appreciated that the resource site (e.g., oilfield 200) may contain a variety of geological structures and/or formations, sometimes having extreme complexity than those depicted. In some locations within the subterranean structure 204 may be below the water line such that fluid may occupy pore spaces of the one or more formations depicted. Each of the measurement devices may be used to measure properties of the formations and/or other geological features within the subterranean structure 204. While each acquisition tool is shown as being in specific locations at the resource site (e.g., oilfield 200), it will be appreciated that one or more types of measurement may be taken at one or more locations across one or more fields or other locations for comparison and/or for analysis and/or for integration with data captured at the resource site. The data captured from various sources, such as the data acquisition tools of FIG. 1F, may then be processed and/or evaluated. In some embodiments, seismic data may be displayed in a static data plot 208.1 from the data acquisition tool 202.1 and may be used to determine characteristics of the subterranean formations and other geological features associated with the resource site. The core data shown in the static plot 208.2 and/or log data from the well log 208.3 may be used to determine various characteristics of the subterranean formation. The production data from graph 208.4 may also be used to determine fluid flow reservoir characteristics as the case may require. In some embodiments, the captured data from the resource site may be used to generate models that facilitate additional analysis of the subterranean structure 204 of the resource site.

FIG. 1G illustrates a resource site (e.g., oilfield 300) for performing production operations in accordance with implementations of various technologies and techniques described herein. As shown, the resource site has a plurality of wellsites 302 operatively connected to central processing facility 354. The resource site configuration of FIG. 1G is not intended to limit the scope of the oilfield application system. Part, or all, of the resource site may be on land and/or sea. Also, while a single resource site with a single processing facility and a plurality of wellsites is depicted, any combination of one or more resource sites, one or more processing facilities 354 and one or more wellsites 302 may be present according to some embodiments.

Each wellsite 302 may have equipment associated with one or more wellbores 336 within the subterranean formation 306 of the resource site. In particular, the wellbores 336 may extend through or into the subterranean formations 306 including reservoirs 304. These reservoirs 304 may contain liquid and/or gaseous fluids, such as hydrocarbons. In some embodiments, the wellsites 302 may draw fluid to and/or from the reservoirs and may pass said fluids to processing facilities via surface networks 344. The surface networks 344 may have tubing and control mechanisms for controlling the flow of fluids from the wellsite 302 to processing facility 354.

Attention is now directed to FIG. 1H, which illustrates a side view of a marine-based survey 360 of a subterranean subsurface 362 in accordance with one or more implementations of various techniques described herein. Subsurface 362 may include seafloor surface 364. Seismic sources 366 may include marine sources such as vibroseis or airguns, which may propagate seismic waves 368 (e.g., energy signals) into the Earth over an extended period of time or at a nearly instantaneous energy level provided by impulsive or pulse sources. The seismic waves may be propagated by marine sources as a frequency sweep signal. For example, marine sources of the vibroseis type may initially emit a seismic wave at a low frequency (e.g., 5 Hz) and increase the seismic wave frequency to a high frequency (e.g., 80-90 Hz) over time. In some embodiments, the component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data. In some implementations, each streamer (e.g., comprised in the streamer array 374) may include streamer steering devices such as a bird, a deflector, a tail buoy and the like, which are not illustrated in FIG. 1H. The streamer steering devices may be used to control the position of the streamers (e.g., comprised in the streamer array 374) in accordance with the techniques described herein. In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is may be referred to as the downward reflection point.

According to some implementations, the electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Typically, marine seismic acquisition systems may tow each streamer comprised in the streamer array 374 to the same depth (e.g., 5-10 m) within a body of water (e.g., the sea). However, marine based survey 360 may tow each streamer comprised in streamer the array 374 to a plurality of different depths as indicated in FIG. 1H such that seismic data may be acquired and processed in a manner that avoids the effects of destructive interference due to sea-surface ghost waves. For instance, marine-based survey 360 of FIG. 1H illustrates eight streamers towed by vessel 380 at eight different depths. The depth of each streamer may be controlled and maintained using the birds disposed on each streamer.

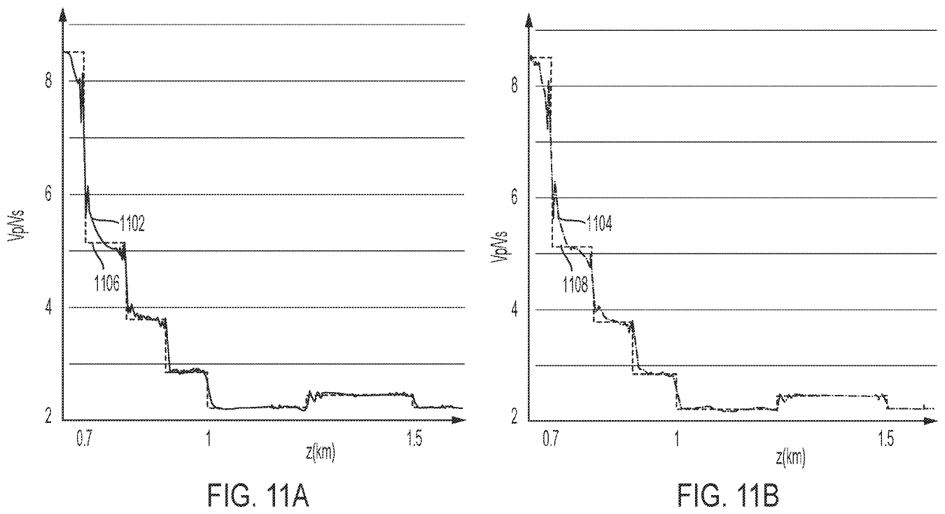

Attention is now directed to FIG. 11 that depicts a marine electromagnetic survey system 382 in accordance with some implementations of this disclosure. The electromagnetic survey system 382 may use controlled-source electromagnetic (CSEM) survey techniques, but other electromagnetic survey techniques may also be used. In particular, marine electromagnetic surveying may be performed by a survey vessel 384 that moves in a predetermined pattern along the surface 385 of a body of water such as a lake or the ocean. The survey vessel 384 may be configured to pull a towfish (an electric source) 386, which is connected to a pair of electrodes 388. During the survey, the survey vessel 384 may stop and remain stationary for a period of time while obtaining measurements, while in some circumstances, the survey vessel 384 may remain underway while obtaining measurements. Furthermore, the survey vessel 384 may be coupled via a signal line 394 to one or more sensor devices 395 and 396 which are configured to work independently or in association with the towfish 386 and/or electrodes 3880

Attention is now directed to methods, techniques, and workflows for processing and/or transforming collected data that are in accordance with some embodiments of this disclosure. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept may be applicable to the procedures, methods, techniques, and workflows as discussed herein. This iterative refinement can include use of feedback loops executed on an algorithmic basis, such as at a computing device (e.g., computing system 100 of FIG. 1A), and/or through manual control mechanisms based on user determinations or user inputs regarding whether a given step, action, template, or model has become sufficiently accurate.

### Embodiments

According to some embodiments of this disclosure, the disclosed methods are directed to: generating PP-wave and PS-wave pre-stack images; generating associated PP-wave and PS-wave point spread functions (PSFs); forming or organizing PP-wave and/or PS-wave synthetic pre-stack images with their corresponding seismic misfit data; and independently or simultaneously minimizing the PP-wave and PS-wave seismic misfit data by updating and/or optimizing and/or revising earth model properties or geological model parameters of a geological model.

For example, generating PP-wave and PS-wave pre-stack images may comprise migrating using a depth imaging process for which one or more point spread functions (PSFs) can be generated. For instance, the depth imaging process may comprise a ray-based (e.g., a Kirchhoff-based) depth migration process for which the PSFs can be generated. In addition, the generated PP-wave and the PS-wave pre-stack images may be partitioned using, for example, attribute data (e.g., key attribute data such as subsurface incident angle data) associated with the PP-wave and/or PS-wave such that the attribute data can be related to an angle used in the generation and/or configuration and/or formulation of the PP-wave and/or PS-wave reflectivity operators.

Furthermore, generating the associated PP-wave and PS-wave spread functions (PSFs) may include using PP-wave PSF(s) such that PP-wave PSF(s) comprise impulse responses or impulse response data associated with the PP-wave blurring (e.g., modelling and migration) operator linked to or otherwise associated with the migration process used to generate the PP-wave images. Furthermore, generating the associated PP-wave and PS-wave point spread functions (PSFs) may include using PS-wave PSF(s) such that PS-wave PSF(s) comprise impulse responses or impulse response data associated with PS-wave blurring (e.g., modelling and migration) operator linked to or otherwise associated with the migration process used to generate the PS-wave images. In addition, the generated PP-wave and/or PS-wave PSFs may be partitioned using, for example, similar key attribute data related to the corresponding images.

According to some embodiments, forming the PP-wave and/or PS-wave synthetic pre-stack images together with their corresponding seismic misfits includes using PP-wave synthetic images such that the PP-wave synthetic images may be formed based on convolving, PP-wave PSF(s) with a resultant PP-wave reflectivity derived through application of a PP-wave reflectivity operator on a given geological model (e.g., earth model), for each partition of the PP-wave pre-stack images. In addition, forming the PP-wave and/or PS-wave synthetic pre-stack images together with their corresponding seismic misfits includes using PS-wave synthetic images such that the PS-wave synthetic images may be formed based on convolving PS-wave PSF(s) with a resultant PS-wave reflectivity derived through application of a PS-wave reflectivity operator applied on the geological model (e.g., earth model), for each partition of the PS-wave pre-stack images. Furthermore, each PP-wave and/or PS-wave synthetic image may be compared to respective PP-wave real image and/or PS-wave real image derived from generating the PP-wave and/or PS-wave pre-stack images and thereby form PP-wave and/or PS-wave seismic misfit data.

In some embodiments, simultaneously minimizing the PP-wave and/or PS-wave seismic misfits by updating and/or optimizing and/or revising earth model properties or geological model parameters of the geological model may comprise using, for example, a gradient-based optimization process that incorporates a plurality of regularization variables and/or constraint variables in addition to the two sets of the PP-wave data and/or PS-wave misfit data. Moreover, the resultant geological model properties may benefit from reduced ambiguity enabled by joint exploitation of PP-wave and PS-wave reflections and/or from suitable mitigation of PP-wave and PS-wave illumination effects that distort PP-wave and PS-wave amplitude data derived from a depth migration process.

According to some embodiments, a PP-PS Least-squares migration process using PSF(s) may be applied to reduce the foregoing PP-wave and/or PS-wave seismic misfit data by inverting, for example, for PP-wave and/or PS-wave reflectivities independently of any geological model (e.g., earth model). For instance, if the PP-wave and/or PS-wave seismic misfits data described above may be minimized by updating and/or revising and/or optimizing associated PP-wave and/or PS-wave reflectivity estimates data used in the generation and/or formation of the PP-wave synthetic image and/or PS-wave synthetic images. In addition, any partitioning of attribute or properties data (e.g., key attribute data) can be employed in the minimization operation. For example, the attribute or properties data may comprise offset data, azimuth data, offset vector tiles data, etc. According to some embodiments, the PP-wave and/or PS-wave reflectivities can be derived simultaneously (e.g., within a simultaneous inversion scheme embedding PP-PS registration) and/or generated through independent inversion processes. Furthermore, resultant PP-wave and PS-wave reflectivities, which are compensated for their respective illumination effects, can be used for joint PP-PS structural interpretation operations as well as joint PP-PS amplitude inversion operations.

In some embodiments, the disclosed solution can be extended to reflected modes of transmitted waves other than those discussed herein. For example, the disclosed solution is not restricted to PP-wave and PS-wave reflections but can be applied to other reflected modes where: waves (e.g., seismic waves) get reflected and possibly converted once (and only once); exploitable depth-migrated images and PSF(s) are available for the resultant wave mode; a suitable formulation of the reflectivity operator is available for the resultant wave mode. It is appreciated that the inversion problem can comprise minimizing simultaneously N seismic misfits data (e.g., N seismic misfits terms or variables) as discussed above, where N is the number of different reflected modes used in the process.

Some approaches to migration/inversion regard data, d, as the result of a linear modelling operator, M, applied to a reflectivity model, r given by: d=Mr. The least-squares inverse to this problem is given by:

$$\hat{r} = {( {M}^{*} M )}^{- 1} {M}^{*} d , \qquad ( 1 )$$

where M^{*}, the adjoint of modelling, is the migration operator. The true reflectivity model and the migrated image, I=M^{*}d, are related by the following relationship:

$$I = {M}^{*} M r = Hr , \qquad ( 2 )$$

where the Hessian operator, H=M^{*}M, defines multidimensional impulse response data of the modeling (e.g., demigration modeling) and migration process at any point scatterers of the subsurface. An approximate Hessian operator HI generated using a set of discrete and localized multi-dimensional impulse response filters or point spread functions (PSFs) may be determined. The approximate Hessian operator HI may be thought of as a measure of illumination that reflects effects of velocity variation and acquisition footprint associated with a seismic reflected wave. If the requirement that the modeling operator and the migration operator be related to each other is relaxed, then operator H is no longer a Hessian operator but may still be considered as an operator that blurs the true reflectivity model to give an image (e.g., blurring operator image).

According to some embodiments, equations (1) and (2) form the basis of the disclosed least-squares migration techniques, which is used to invert seismic data or depth-migrated image data derived therefrom, to obtain an estimate of the reflectivity model. In order to go one step further and enable direct inversion of a seismic image to generate geological properties (e.g., earth elastic properties), the reflectivity model may be expressed as a plane-wave angle-dependent reflectivity operator (R) applied to an elastic geological/earth model (m) defined by a set of elastic properties based on the following relationship:

$$I = {M}^{*} M R ( m ) = H R ( m ) \qquad ( 3 )$$

According to some embodiments, the disclosed process of deriving geological properties (e.g., earth elastic properties) directly from seismic depth-domain images or gathers will be referred to as depth-domain inversion.

### Simultaneous PP-PS Inversion For Geological/Earth Property Generation

The above scattering framework may be applied to primary (P-wave) reflections. As well as for non-converted PP-wave reflections, the disclosed approach may be applied to other types of converted reflections, provided that exploitable depth-migrated images and PSFs can be generated for these reflections, and that a suitable reflectivity operator can be created or formulated. In an exemplary embodiment, PS-wave reflections fall under the category of the other types of converted reflections mentioned above. According to some embodiments, PS-wave reflections can comprise a signal propagated as a compressional wave (P mode) from a source to the reflection/conversion point and propagated as a (vertically polarized) shear wave (e.g., SV mode) from the reflection point to the seismic receiver.

Considering equation (3) from the perspective of a PS-wave image, Iₚₛ, formed through depth migration of a PS-wave reflection data, the modelling and migration operators as well as the Hessian operator, Hₚₛ, rely on both P-wave and S-wave propagation using a preliminary estimation of the long wavenumbers of the P-wave and S-wave velocities. The possibly non-linear plane-wave reflectivity operator, Rₚₛ, is characteristic of the angle-dependent reflectivity at the reflection P-to-S conversion point and can take various forms. Thus, the inverse problem being solved may be formulated through the following joint linear system:

$$\{ \begin{matrix}{I}_{P P} = {H}_{P P} {R}_{P P} ( m ) \\ {I}_{PS} = {H}_{PS} {R}_{P S} ( m )\end{matrix} , \qquad ( 4 )$$

where the PP and PS subscripts refer to terms associated with PP-wave and PS-wave reflections, respectively. As both PP-wave and PS-wave reflectivity operators can be expressed as a function of the subsurface incident angle, the disclosed solution may be partitioned by the incident angle. However, it is possible to work with partitions other than those provided in this disclosure provided that said partition attribute data can be related to the angle used to design the reflectivity operators.

The geological or earth model, m, parameterized for instance by acoustic impedance, ratio of P-wave velocity and S-wave velocity (Vp/Vs ratio) and density properties can be determined by seeking the model that best satisfies joint system (4) in the least-squares sense. This may be done by comparing, for each wave mode, the real image (as defined by the left terms) to a synthetic image HR(m) as defined by the right terms. Each synthetic image may be obtained by applying an estimate of the Hessian operator to the reflectivity derived from the application of the reflectivity operator to a given geological or earth model. The disclosed earth or geological model, according to some embodiments, is one that minimizes the misfits for the two wave modes, PP-wave and PS-wave modes, simultaneously. The data misfit term to be minimized can be expressed as:

$$\frac{1}{2} ( {‖ {C}_{PP}^{- 1 / 2} [ {H}_{P P} {R}_{P P} ( m ) - {I}_{P P} ] ‖}^{2} + {‖ {C}_{PS}^{- 1 / 2} [ {H}_{P S} {R}_{P S} ( m ) - {I}_{P S} ] ‖}^{2} ) , \qquad ( 5 )$$

where C_{PP} and C_{PS} are the data covariance operators for the two data misfit terms and contain a (space-and/or angle-variant) measure of data uncertainty for each set of data. In particular the data covariance operators, according to some embodiments, control the relative priority or importance given in each of these terms during optimization. Furthermore, additional regularization terms can be employed during minimization to mitigate the ill-posed nature of the problem. For instance, terms penalizing the misfit between the geological or earth model and a given prior geological or earth model and/or terms enforcing sparseness of the R_{PP}(m) and R_{PS}(m) reflectivities associated with the geological or earth model may be implemented.

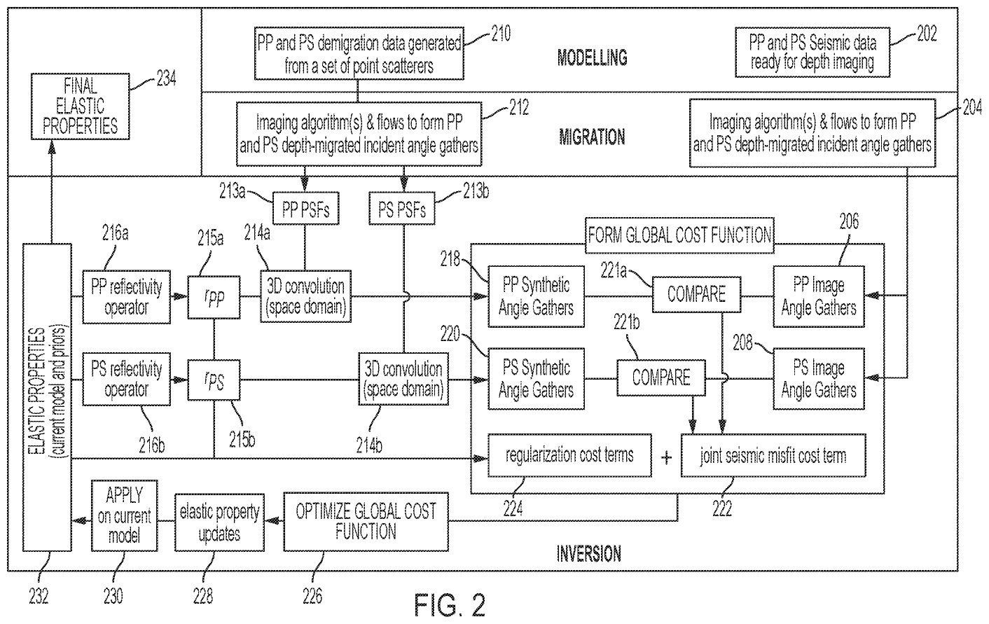

FIG. 2 shows an exemplary workflow for generating elastic property data associated with a geological or earth model based on the disclosed inversion procedure. At block 202, PP-wave and/or PS-wave data may be received by a data engine. According to some embodiments, the data engine may be comprised in a geological processing software tool which prepare the PP-wave and/or PS-wave data so they can be imaged. In addition, the PP-wave and/or PS-wave data may be derived from, for example: seismic data captured by one or more sensors at a resource site such as the resource site described in this disclosure; synthetic seismic data generated from tests or simulations and which are similar to seismic data captured by one or more sensors at the resource site; and/or seismic data derived from sites similar to, or distinct from, the resource site provided in this disclosure.

At block 204 of FIG. 2, an imaging process is applied to the received PP-wave and PS-wave data. For example, the imaging process may include a depth imaging process that applies ray-based depth migration processes to the received PP-wave and/or PS-wave data to generate first PP-wave and PS-wave migrated data. At blocks 206 and 208, transform operations may be applied to the first PP-wave and PS-wave migrated data to generate PP-wave image angle gathers data and PS-wave image angle gathers data, respectively. According to some embodiments, the transform operations comprise creating seismic images partitioned by the incident angle at the point of reflection.

Turning to block 210, PP-wave and PS-wave demigration (e.g., diffracted) data may be generated from a modelling (demigration) operation using a reflectivity model that comprises a set of point scatterers across the subsurface, where each point scatterer diffracts the incident waves, giving rise to diffracted seismic events. These points can be located on a regular grid or placed at irregular locations in the subsurface. At block 212, an imaging process similar to the one used in block 204 is applied to the PP-wave and PS-wave demigration data to obtain PP-wave PSF data (213a) and PS-wave PSF data (213b), which will form the first and second inputs to convolution, respectively. It is appreciated that, at blocks 213a and 213b, transform operations similar to the ones used at blocks 206 and 208 may be applied to ensure that PP-wave PSF data and PS-wave PSF data are partitioned in the same way as the corresponding PP-wave and PS-wave image angle gathers of blocks 206 and 208, respectively. It is also appreciated that calibration operations (e.g. using information at boreholes) may be conducted to ensure that PP-wave PSF data and PS-wave PSF data reproduce as best as possible the modelling and migration effects present in the respective PP-wave and PS-wave image angle gathers. It is further appreciated that block 210 and 212 may be combined to generate PP-wave or PS-wave PSF data in one single process simulating modelling and migration operations.

At block 214, the first convolution input (PP-wave PSF data) is convolved at block 214a with a first reflectivity model r_{PP} derived from application of a PP-wave reflectivity operator (block 216a) on a given (current) set of earth model properties (block 232). This first convolution operation thereby generates, at block 218, PP-wave synthetic angle gathers data. Similarly, the second convolution input (PS-wave PSF data) is convolved at block 214b with a second reflectivity model r_{PS} derived from application of a PS-wave reflectivity operator (block 216b) on the same given (current) set of earth model properties (block 232). This second convolution operation thereby generates, at block 220, PS-wave synthetic angle gathers data. It is appreciated that the first convolution and/or the second convolution comprise a 3-dimensional convolution (e.g., spatial convolution) in the space domain and may include interpolation of the generated PP-wave PSF data and PS-wave PSF data to get a full estimate of the required Hessian operators H_{PP} and H_{PS}, respectively, as described in equations (4) and (5). It is further appreciated that the given (current) set of earth model properties of block 232 is a set of seismic elastic properties that characterize the subsurface (e.g. acoustic impedance, ratio of P-wave velocity and S-wave velocity, density). As a starting point for the inversion procedure, this model can be set for instance to be equal to a prior model comprising low-wavenumber estimates of the various elastic properties, derived by other means (e.g. geological prior information, information at boreholes, etc.)

Turning to blocks 221, the PP-wave synthetic angle gathers data from block 218 may be compared, at block 221a, with the PP-wave image angle gathers data from block 206 to generate a first seismic misfit data. Similarly, the PS-wave synthetic angle gathers data from block 220 may be compared, at block 221b, to the PS-wave image angle gathers data from block 208 to generate a second seismic misfit data. The first seismic misfit data and the second seismic misfit data may be coalesced together at block 222 to form the joint seismic misfit term and combined with terms or parameters (block 224) that help regularizing the inversion problem (regularization cost terms). This can include, for instance, regularization terms penalizing the misfit between the current model and the prior model previously described and/or terms enforcing sparseness of the r_{PP} and r_{PS} reflectivity models, etc. Preconditioning of the inverse problem can also be envisaged (e.g. to enforce smoothness of the inverted property fields and/or speed up convergence). All the above are used to form the global cost function to be minimized/optimized.

Optimization of the global cost function can be conducted using a variety of optimization (iterative) algorithms, for instance using Limited Memory Broyden-Fletcher-Goldfarb-Shanno (L-BFGS) algorithm. The iterative inversion problem comprises finding the geological model (set of seismic elastic properties) that best minimizes the global cost function, according to some embodiments. At each iteration, a set of property updates (block 228) is derived and applied to the current geological model to form a new model (block 232). The inversion procedure continues until the global cost function reaches a minimum value (cannot be optimized further) or until the process reaches a pre-defined number of iterations for instance. At the end of the procedure, the updated geological model is output and constitutes the final model of block 234. The set of elastic properties associated with the final geological model may be displayed on, for example, a display device.

The disclosed solution beneficially accounts for the illumination effects associated with limited seismic acquisition systems, complex wave propagation in the subsurface and limited-bandwidth source wavelets through the introduction of two sets of PSFs, characterizing the PP-wave and PS-wave Hessian operator, respectively. These PSFs as applied in this disclosure constitute 3-dimensional wavelets that capture and/or correct for the space, dip, and angle-variant illumination and wavelet stretch effects present in the respective PP-wave and PS-wave images. The proposed procedure delivers improved geological or earth model estimates in areas subject to significant illumination variations, provided that the P-wave and S-wave velocity models used to form PSFs represent or approximately represent or substantially represent actual velocities associated with the propagated seismic waves or at least contain the main features responsible for the observed illumination variations associated with the propagated seismic waves.

### Approximation of the PS Hessian Operator Through Point Spread Functions

According to some embodiments, the disclosed solution beneficially enables generating both PP-wave PSF(s) and/or PS-wave PSF(s). For each mode (e.g., PP-wave mode and/or PS-wave mode), PSF(s) may be generated for a set of point scatterers whose locations may or may not differ between the two modes. Furthermore, a full estimate of at least one Hessian operator associated with the PP-wave and/or PS-wave may be generated or otherwise derived based on executing interpolation operations on the generated PSF(s).

In some implementations, PSF(s) can be generated (e.g., computed) using numerical simulations by applying, successively, computing operations to modelling seismic waves and to seismic data migration. However, this two-step process, relying on generating and migrating diffracted data, has non-negligible costs that may be avoided when ray-based migrations such as Kirchhoff migration is employed. Under a local plane-wave approximation, rays offer an optimal way to compute PSF(s), including PS-wave PSF(s), in one process. In order to simulate as closely as possible the effects present in the Kirchhoff depth-migrated images, the disclosed approach relies on non-adjoint modelling and migration operators by forming PSF(s) in one single computing operation using two distinct sets of weighted Green's functions, where the Green's function is a solution to the point-source wave equation. The first set simulates and characterizes the migration operation, the second set simulates and characterizes the modelling operation.

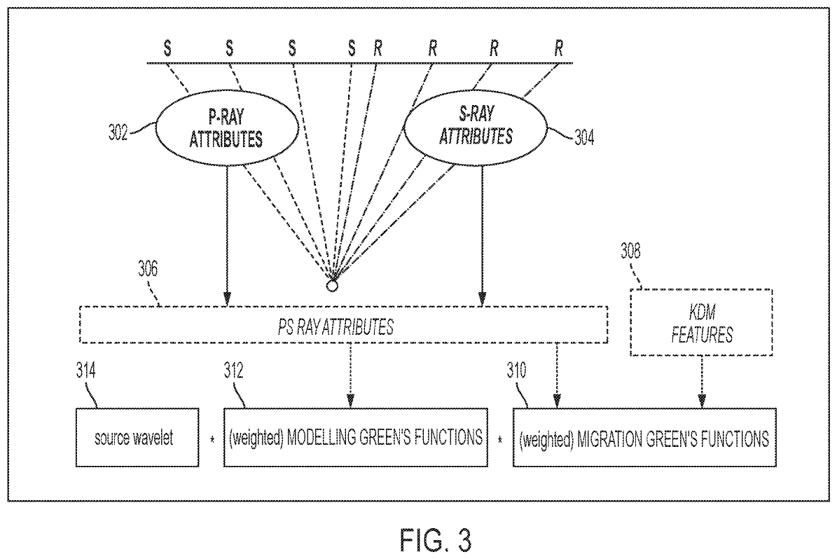

According to some embodiments, PS-wave PSF(s) may be generated by computing kinematic and/or dynamic PS-wave ray attributes including travel time data, slowness vector data, energy level data for each source-receiver pair of the dataset geometry used to form the PS-wave image. For example, PS-wave ray attributes may be computed by combining P-wave ray attributes, derived from P-wave ray tracing between the source and the point scatterer, and S-wave ray attributes, derived from S-wave ray tracing between the receiver and the point scatterer as indicated in FIG. 3. In particular, FIG. 3 shows the use of P-wave ray attributes 302 and S-wave ray attributes 304 which, in combination, are applied to generate PS-wave ray attributes 306. The resulting PS-wave attributes are used, on one hand, to generate the modelling term (e.g., weighted modeling Green's functions 312) and, on the other hand, are combined with features derived from the Kirchhoff depth migration (KDM) process to generate the migration term (e.g., weighted migration Green's functions 310).

Migration term 310, modelling term 312, and source wavelet 314 are then combined to form PS-wave PSF(s).

In weakly anisotropic elastic media, ray tracing computing operations may be implemented using first-order approximations of the anisotropic ray tracing equations.

In practice, PS-wave ray attributes may be derived through interpolation using pre-computed P-wave and S-wave ray attribute data.

PSFs may be formed by combining source wavelet data with two weighted sets of Green's functions as indicated in FIG. 3. The first set (e.g. weighted migration Green's functions 310) may simulate the effects of the migration operator used to generate the PS-wave image. Migration Green's functions may be weighted so as to reproduce anti-aliasing effects and/or limited aperture effects as well as effects associated with mute functions and weighting schemes or geometrical spreading corrections applied during migration based on, for example, a simplification of the velocity model (e.g., simplified and approximate velocity model) associated with the propagated seismic wave. The second set (e.g. weighted modelling Green's functions 312) may characterize the modelling operation and may capture some of the effects undergone by the PS-wave data that are not accounted for during their pre-processing or migration operations. Geometrical spreading in particular may be approximated through a paraxial approximation and may be further used to weight the modelling Green's functions.

Surface seismic PS-wave Kirchhoff images may be formed out of the horizontal component of the recorded P-to-SV-wave reflected signal or data with vertical component data being ignored in some cases. This may have little impact in a large variety of media, in which SV-waves propagate nearly vertically when they get recorded. However, in situations where significant energy is present on the vertical component, ignoring this component may distort the amplitudes of the PS-wave images and PSF(s) must account for and/or correct for the distortion. This can be done during the formation of the PSF(s), by applying an obliquity term or parameter to each PS-wave ray contributing to the PSF(s), based on the emergence angle of the S-wave ray at the receiver point.

While disclosed ray-based PSF(s) can capture and/or correct for some of the acquisition and/or propagation effects that degrade or otherwise attenuate amplitude data and/or introduce blurring into the seismic images, the ray-based PSF(s) may miss one or more acquisition and/or propagation effects. In some embodiments, elastic transmission effects data are difficult to estimate. In addition, residual attenuation (Q) effects data remaining after imperfect Q-compensations, can also distort depth-migrated amplitudes. Calibration of the PSFs at, for example, one or more wells at a resource site where PP-wave and PS-wave reflectivity profiles are available may be used to improve the estimation of Hessian operators and, in turn, of the inverted geological/earth property estimates, at least in the vicinity of the one or more wells.

This disclosure validates the use of the proposed PS-wave PSFs to capture and/or compensate for the illumination effects associated with the propagated PS-waves. In a first exemplary implementation, PS-wave synthetic images are generated using PS-wave PSF(s) formed with the proposed approach and compared with “real” PS-wave images derived independently through (finite-difference) modelling and Kirchhoff depth migration of the resulting seismic data. In a second exemplary implementation, a depth-domain inversion is applied to processing PS-wave images.

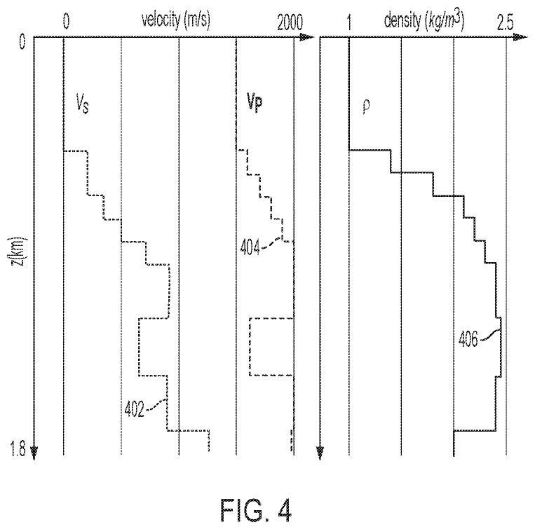

In these two exemplary implementations, a layered elastic geological model derived from well log data associated with a well at a resource site is used. The well log data exhibit contrasts of different amplitude versus offset or amplitude variation with offset (AVO) classes. The elastic model is shown in FIG. 4. In particular, this figure shows the depth profiles for S-wave velocity data (V_{S}) 402, P-wave velocity data (V_{P}) 404, and density data (ρ) 406. In this example, a shot gather using a 3-dimensional finite-difference elastic modelling process is generated. A Ricker wavelet centered at about 15 Hz is used as the source wavelet. The source, in this case, is located at a depth of 20 m below water while the receivers are located on the seafloor at a depth of about 500 m and record all elastic wavefield components of the transmitted seismic wave including pressure data and particle velocity data. Using this shot gather, a complete 2-dimensional elastic dataset spanning 12 km with a maximum offset of about 4 km is simulated.

In these two exemplary implementations, the data received by the receivers is pre-processed including noise removal as well as separation of PS-wave data from non-PS-wave data. To simulate illumination effects associated with propagated PS-wave, data traces associated with a common mid-point (CMP) located between 8 and 10 km are randomly decimated. Random decimation is applied differently for different offset bands, to generate amplitude-versus-angle (AVA) response distortions in the data. Offset values comprised between 0-500 meters (m), 500-1000 m, and 1000-4000 m see 40%, 70% and 20% of their data decimated, respectively.

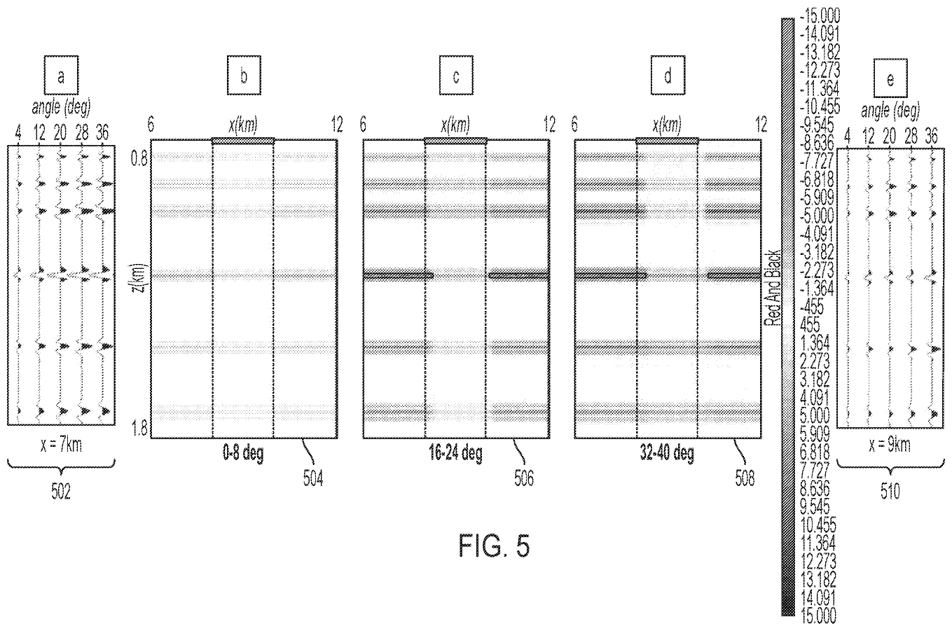

The resulting (decimated) PS-wave dataset is then migrated using Kirchhoff depth migration. PS-wave angle gathers (AG) are generated with a sampling of 8 degrees. FIG. 5 shows PS-wave Kirchhoff depth-migrated AGs for three angle ranges respectively under b (plot 504), c (plot 506), and d (plot 508). In these figures, the grayscale color bar reflects the magnitude of the seismic amplitudes, while the dark grey line at the top indicates the area of decimation. The imprint of the illumination variations created by the missing data can be observed on the individual AGs, which suffer from a drop in amplitude in the central area.

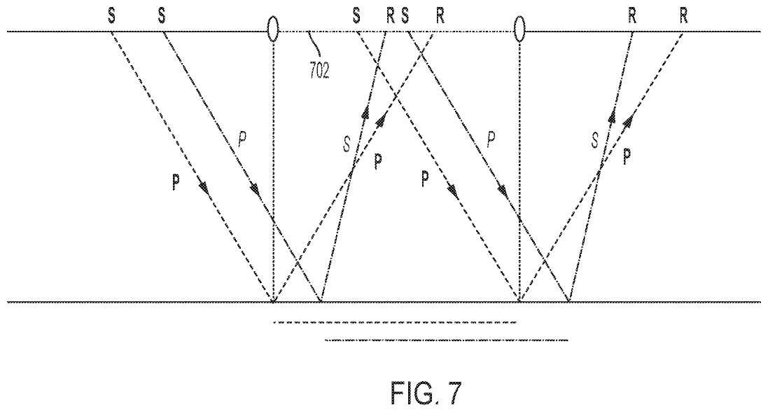

As expected, the illumination imprint is not located exactly underneath the area of decimation as it would be for PP-wave reflections, but is shifted towards the right receiver side, due to the asymmetrical nature of PS-wave reflections. This is illustrated in FIG. 7, which provides a schematic of the imprint of PP-wave and PS-wave illumination induced by the data decimation process, for a given angle. Data traces whose common mid-point (CMP) is located on or about the dashed line 702 are randomly decimated. While the area of the reflector affected by the decimation is located right underneath the affected CMPs in the case of PP-wave reflections, it is shifted towards the receiver side for PS-wave reflections, due to the asymmetrical nature of the PS-wave reflection path. From FIG. 5 (plots 504,506,508), it is appreciated that the larger the angle, the larger the shift.

Plot 502 of FIG. 5 represents a PS-wave Kirchhoff angle common image gathers (ACIG) for a position located far away from the decimation area (e.g., x=7 kilometers (km)) while plot 510 represents a similar ACIG for a position right in the middle of the decimated area (e.g., x=9 km). These two plots indicate that the amplitude variations with angles (AVA), can be significantly impaired by the illumination variations associated with the data decimation.

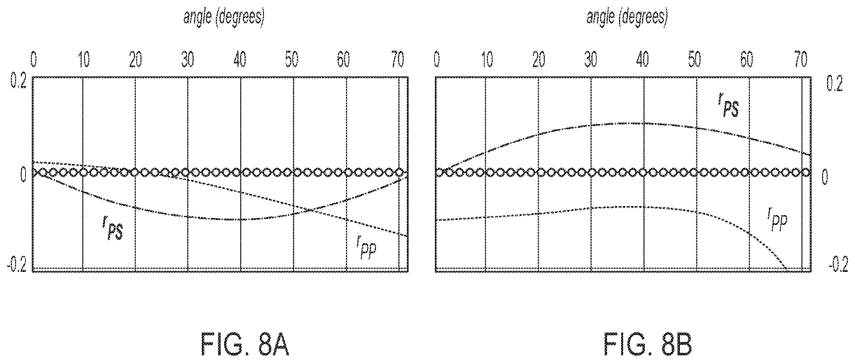

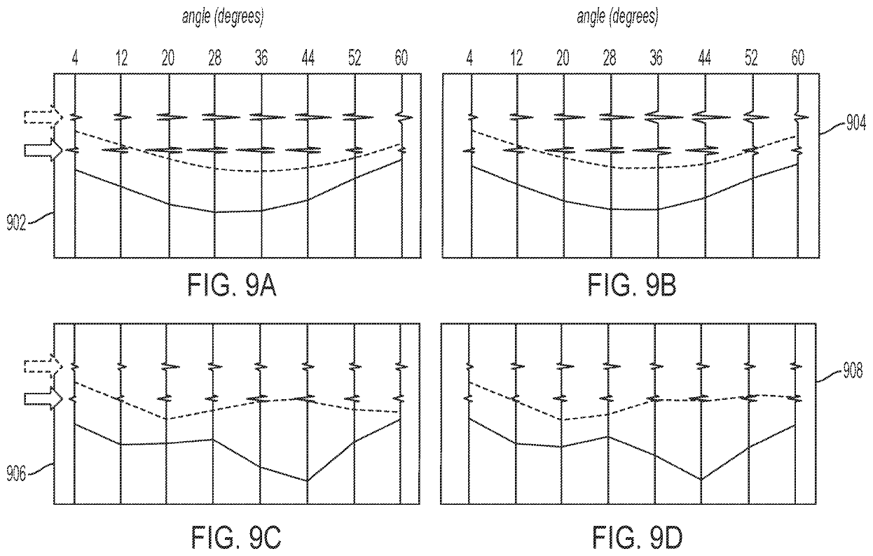

The AVA response at these two locations (away and within the decimation area) is analysed further for two horizons associated with different classes. FIGS. 8A and 8B show the expected PS-wave reflectivity, analytically determined using CREWES Zoeppritz explorer software tool, for these two contrasts. In particular, these figures provide the analytical PS-wave reflectivity (r_{PS}) curve data for contrast located at z=1 km (FIG. 8A) and z=1.24 km (FIG. 8B). Both PS-wave reflectivity curves show similar trends but with opposite polarity. FIGS. 9A and 9C show the associated (unsigned) AVA responses extracted from the PS-wave Kirchhoff ACIGs for contrast located at z=1 km (indicated by the dashed-line arrow) and contrast located at z=1.24 km (indicated by the plain-line arrow). These plots display the root-mean-square (RMS) amplitude trends and as such do not reflect polarity. While they are quite similar to the analytical curves for locations away from the decimated area (FIG. 9A), they are strongly distorted in the area of decimation (FIG. 9C).

The ability of the disclosed PS-wave PSF(s) to model illumination effects accurately is first checked through a forward modelling experiment. PS-wave PSF(s) are generated every 200 m vertically and every 150 m laterally and calibrated to the received seismic data using a global operator. The generated PSF(s) are then be used to form PS-wave synthetic images through a 3-dimensional convolution with the true PS-wave reflectivity model obtained through applying a non-linear PS-wave Zoeppritz reflectivity operator on the true geological/earth model properties.

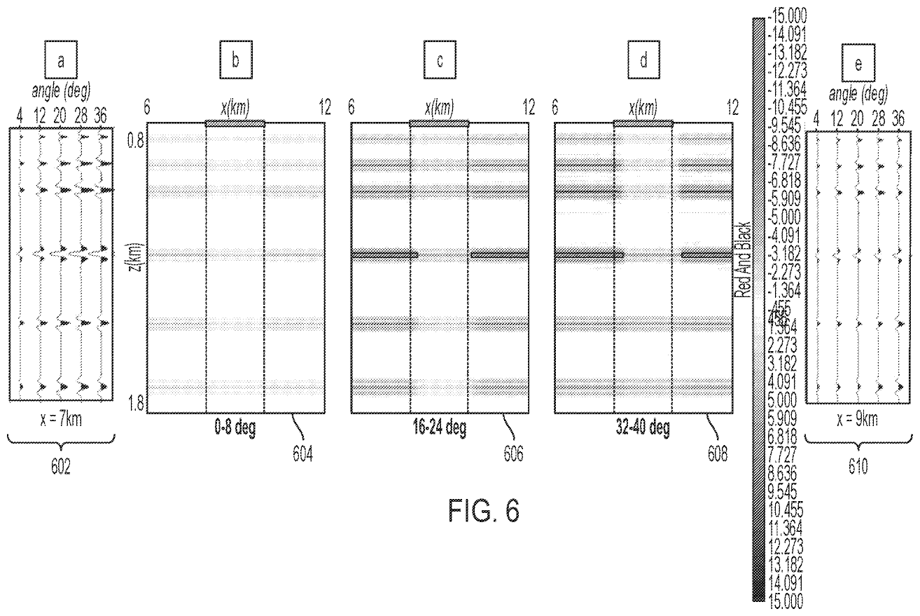

The obtained PS-wave synthetic AGs are depicted in plots 604, 606 and 608 of FIG. 6 for the same angle bands as the ones displayed in FIG. 5. The angle-dependent illumination effects causing a drop in amplitudes in the central part of the sections is accurately captured leading to sections comparable to the real PS-wave Kirchhoff AGs, for each angle band.

In addition, the induced AVA distortions match closely those observed in the real PS-wave Kirchhoff ACIGs, as shown in FIGS. 9A, 9B, 9C, and 9D. FIGS. 9A, 9B, 9C, and 9D compare the root-mean-square (RMS) AVA responses for horizons located at 1 km depth (indicated by the dashed-line arrow) and 1.24 km depth (indicated by the plain-line arrow). Left plots 902 and 906 show the responses extracted from the PS-wave Kirchhoff ACIGs, whereas right plots 904 and 908 show the responses extracted from the PS-wave synthetic ACIGs generated with the PS-wave PSFs. Top plots 902 and 904 are generated for a position away from the decimated area whereas bottom plots 906 and 908 are generated in the center of the decimated area. The significant AVA distortions present in the PS-wave Kirchhoff ACIGs in the decimated area (plot 906) are accurately modelled in the PS-wave synthetic ACIGs generated with the PS-wave PSFs (plot 908).

The ability to model PS-wave illumination effects through PS-wave PSFs enables compensating for these effects within a depth-domain inversion scheme, as provided in this disclosure.

In the second exemplary implementation, geological/earth model properties are generated through depth-domain inversion of PS-wave data. In this specific example, the generated PS-wave PSFs are used within the inversion process defined in equation (5), without the PP-related term. The inversion process is parameterized in terms of acoustic impedance, ratio of P-wave velocity and S-wave velocity (Vp/Vs) and density, and performed using 5 angle bands, up to 40 degrees. The starting geological model is a 100 m-smoothed version of the true geological model properties. Since PS-wave reflectivity may be mostly sensitive to S-wave-related properties (as well as density property), it would not to be expected that inversion of PS-wave data alone enables derivation of accurate acoustic impedance property, which is mostly constrained by PP-wave data. However, in this experiment, Vp/Vs property is sufficiently constrained and used to demonstrate the validity of the disclosed approach.

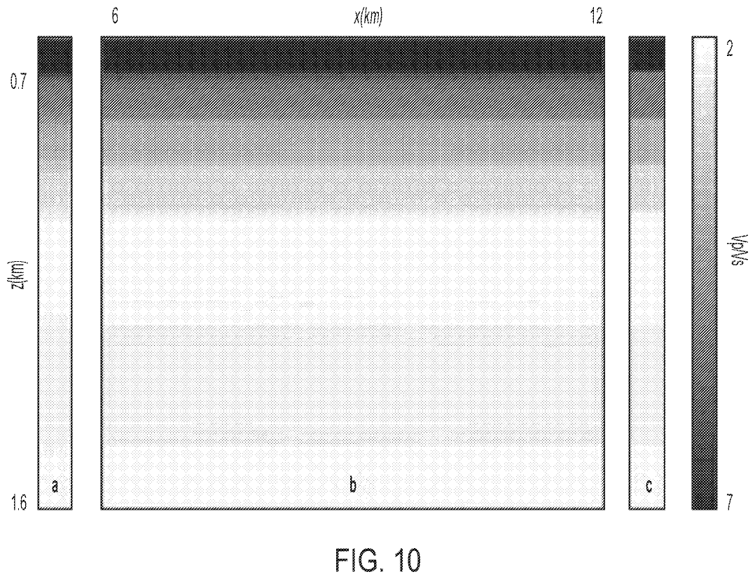

The Vp/Vs geological property derived through depth-domain inversion of PS-wave data is depicted in section (b) of FIG. 10. The starting Vp/Vs geological property is displayed in section (a) of FIG. 10, while the true Vp/Vs geological property is displayed in section (c) of FIG. 10. The inverted property field (section b) shows a fair match with the true Vp/Vs property field (section c). Most importantly, no significant illumination imprint can be observed in the inverted property field (section b). The imprint of illumination in the central part of the properties of the geological model is substantially mitigated, leading to quite homogeneous layers. No lateral smoothing or prior model constraints was used during this inversion. FIGS. 11A and 11B show the inverted Vp/Vs depth profile data 1102 and 1104 associated with FIG. 10 (section b) away from the decimation area (FIG. 11A) and right in the middle of the decimated area (FIG. 11B). In both of these figures, the true Vp/Vs profile data is shown as the stepwise lines 1106 and 1108, respectively. The inverted Vp/Vs depth profile data, both in and away from the decimated area, are very similar, indicating that the PS-wave PSFs have adequately accounted for the illumination effects induced by the decimation.

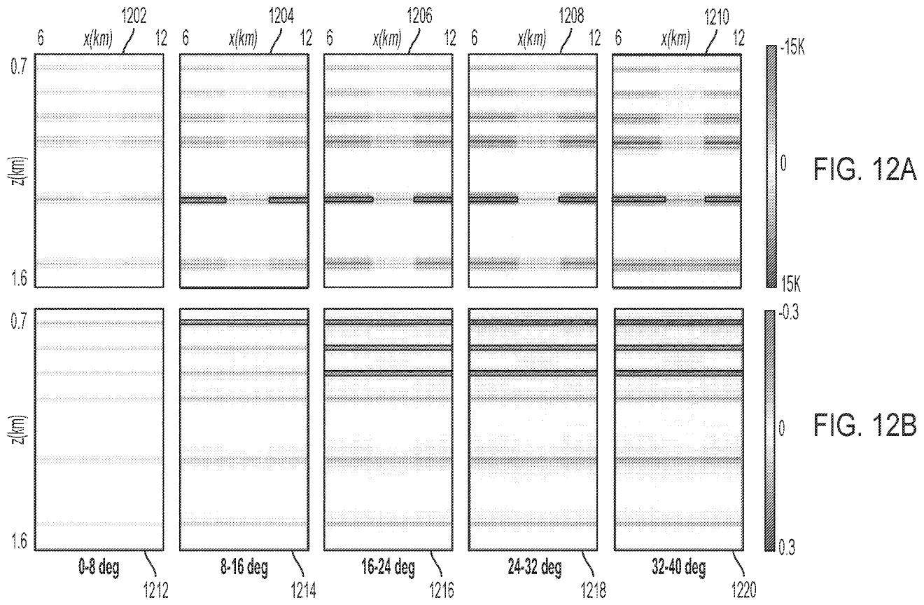

The associated PS-wave reflectivity models output by the disclosed process are shown in FIG. 12B for the five angle bands that were inverted (see plots 1212-1220). For comparison, plots 1202-1210 of FIG. 12A show the PS-wave Kirchhoff AG inputs to the depth-domain inversion process. It is appreciated that the illumination imprint induced by data decimation is hardly visible in the inverted PS-reflectivity AGs, despite being significant in the input PS-wave Kirchhoff AGs.

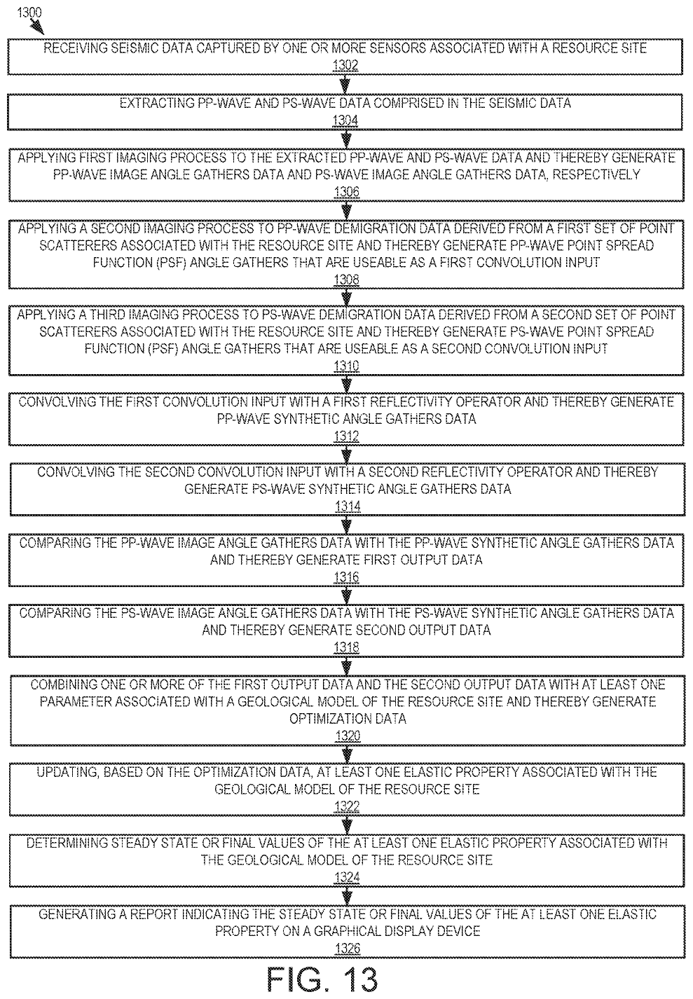

FIG. 13 provides an exemplary detailed workflow 1300 for methods, systems, and computer programs that generate at least one elastic property associated with a geological model of a resource site. It is appreciated that a data engine stored in a memory device may cause a computer processor to execute the various processing stages of the workflow 1300. For example, the disclosed techniques may be implemented as a data engine or a signal processing engine within a geological software tool such that the data engine or the signal processing engine enables the modeling of geological structures in the subsurface of a resource site based on the processes outlined herein.

At block 1302, the data engine receives seismic data captured by one or more sensors associated with a resource site. In some embodiments, the captured seismic data may be transmitted to computing systems proximal to, or distal from, the one or more sensors such that the data engine is comprised in the computing systems.

At block 1304, the data engine may extract PP-wave data and PS-wave data comprised in the received seismic data. In addition, the data engine may apply, at block 1306, a first imaging process to the extracted PP-wave data and PS-wave data and thereby generate PP-wave image angle gathers data and PS-wave image angle gathers data, respectively. Furthermore, the data engine may also apply, at block 1308, a second imaging process to PP-wave demigration data derived from a first set of point scatterers associated with the resource site and thereby generate PP-wave point spread function (PSF) angle gathers (e.g., PP-wave PSF angle gathers data) that are useable as a first convolution input. In addition, the data engine may also apply a third imaging process to PS-wave demigration data derived from a second set of point scatterers associated with the resource site and thereby generate PS-wave point spread function (PSF) angle gathers (e.g., PS-wave PSF angle gathers data) that are useable as a second convolution input as indicated at block 1310. It is appreciated that first imaging process, the second imaging process, and the third imaging process may comprise similar or dissimilar imaging processes.

At block 1312, the data engine convolves the first convolution input with a first reflectivity operator and thereby generates PP-wave synthetic angle gathers data. Similarly, the data engine convolves the second convolution input with a second reflectivity operator and thereby generates PS-wave synthetic angle gathers data as indicated at block 1314.

At block 1316, the data engine may compare the PP-wave image angle gathers data with the PP-wave synthetic angle gathers data and thereby generates first output data. Furthermore, the data engine compares the PS-wave image angle gathers data with the PS-wave synthetic angle gathers data and thereby generates second output data as shown at block 1318.

According to some embodiments, the data engine combines, at block 1320, one or more of the first output data and the second output data with at least one parameter associated with a geological model of the resource site and thereby generates optimization data. The optimization data, according to one implementation, may be used to update an elastic property of a geological model. In particular, and as indicated at block 1322, the data engine may update at least one elastic property associated with the geological model of the resource site. In addition, the data engine may determine (e.g., compute, calculate, or generate) steady state data or final values of the at least one elastic property associated with the geological model of the resource site as shown at block 1324. At block 1326, the data engine may generate a report indicating the steady state or final values of the at least one elastic property on a graphical display device. According to some embodiments, the at least one elastic property comprises one or more of: pore data associated with a geological formation (e.g., rocks) at the resource site; fracture data associated with the geological formation; crack data associated with the geological formation; geological matrix data associated with the geological formation; fluid data associated with the geological formation; stratigraphic data associated with the geological formation; compression data associated with the geological formation; density data associated with the geological formation; sediment data associated with the geological formation; etc.

These and other implementations may each optionally include one or more of the following features.

The first imaging process or the second imaging process or the third imaging process comprises a ray-based depth migration process. Furthermore, at least the first imaging process comprises creating seismic images collected by a reflection angle at a point of reflection of a propagated seismic wavefield associated with the seismic data.

According to some embodiments, convolving the first convolution input with the first reflectivity operator and thereby generate PP-wave synthetic angle gathers data comprises executing a 3-dimensional spatial convolution operation. Furthermore, convolving the second convolution input with the second reflectivity operator and thereby generate PS-wave synthetic angle gathers data comprises executing a 3-dimensional spatial convolution operation.

In exemplary implementations, the PS-wave PSFs are generated by computing kinematic or dynamic PS-wave ray attribute data including travel time data, slowness vector data, energy level data for each seismic source and receiver pair associated with a dataset geometry comprised in the seismic data.

Moreover, the PS-wave ray attribute data may be generated by combining: P-wave ray attribute data derived from P-wave ray tracing between a seismic source and a point scatterer; and S-wave ray attribute data derived from S-wave ray tracing between the receiver and the point scatterer. According to some embodiments, the P-wave ray attribute data and the S-wave ray attribute data, in combination, are applied to generate the dynamic PS-wave ray attribute data while the dynamic PS-wave ray attribute data together with geological attribute data related to a ray-based depth migration process are used to generate the PS-wave PSFs.

According to some embodiments, one or more of the first reflectivity operator and the second reflectivity operator are derived from elastic properties data of a prior geological model associated with the resource site.

It is appreciated that the report discussed in conjunction with flowchart 1300 may be used for at least one of: well placement operations at the resource site; equipment placement operations at the resource site; and surgically locating a subsurface resource at the resource site. In particular, the report, according to some embodiments, includes a multi-dimensional visualization comprising: one or more of image or textual data associated with a geological model of a complex geological formation at the resource site; or one or more of image or textual data associated with a geological model indicating geological heterogeneities that have complex geometries at the resource site. Furthermore, the report may be adapted for use in energy development operations including at least one of: well placement operations at the resource site; equipment placement operations at the resource site; surgically locating a subsurface resource at the resource site; carbon storage operations at the resource site; configuring at least one equipment associated with the energy development operations at the resource site; and implementing safety protocols associated with the energy development operations at the resource site.

It is further appreciated that the first set of point scatterers associated with the resource site and the second set of point scatterers associated with the resource site are the same set of point scatters associated with the resource site.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection this disclosure.

Many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit this disclosure to the precise forms disclosed. Many modifications and variations are possible in view of the above teachings. The embodiments were chosen and described in order to explain the principles of the disclosed subject-matter and its practical applications, to thereby enable others skilled in the art to utilize the disclosed techniques and various embodiments with various modifications as are suited to the particular use contemplated. It is appreciated that the term optimize/optimal and its variants (e.g., efficient or optimally) may simply indicate improving, rather than the ultimate form of ‘perfection’ or the like.

What is claimed is:

1. A method for generating at least one elastic property associated with a geological model, the method comprising:
receiving seismic data captured by one or more sensors associated with a resource site;
extracting PP-wave and PS-wave data included in the seismic data;
applying a first imaging process to the extracted PP-wave and PS-wave data and thereby generate PP-wave image angle gathers data and PS-wave image angle gathers data, respectively;
applying a second imaging process to PP-wave demigration data derived from a first set of point scatterers associated with the resource site and thereby generate PP-wave point spread function (PSF) angle gathers that are useable as a first convolution input;
applying a third imaging process to PS-wave demigration data derived from a second set of point scatterers associated with the resource site and thereby generate PS-wave point spread function (PSF) angle gathers that are useable as a second convolution input;
convolving the first convolution input with a first reflectivity operator and thereby generate PP-wave synthetic angle gathers data;
convolving the second convolution input with a second reflectivity operator and thereby generate PS-wave synthetic angle gathers data;
comparing the PP-wave image angle gathers data with the PP-wave synthetic angle gathers data and thereby generate first output data;
comparing the PS-wave image angle gathers data with the PS-wave synthetic angle gathers data and thereby generate second output data;
combining one or more of the first output data and the second output data with at least one parameter associated with a geological model of the resource site and thereby generate optimization data;
updating, based on the optimization data, at least one elastic property associated with the geological model of the resource site;
determining steady state or final values of the at least one elastic property associated with the geological model of the resource site; and
generating a report indicating the steady state or final values of the at least one elastic property on a graphical display device.

2. The method of claim 1, wherein the first imaging process or the second imaging or the third imaging process includes a ray-based depth migration imaging process.

3. The method of claim 1, wherein at least the first imaging process includes creating seismic images collected by a reflection angle at a point of reflection of a propagated seismic wavefield associated with the seismic data.

4. The method of claim 1, wherein:
convolving the first convolution input with the first reflectivity operator and thereby generate PP-wave synthetic angle gathers data includes executing a 3-dimensional spatial convolution operation; and
convolving the second convolution input with the second reflectivity operator and thereby generate PS-wave synthetic angle gathers data includes executing a 3-dimensional spatial convolution operation.

5. The method of claim 1, wherein PS-wave PSFs are generated by computing kinematic or dynamic PS-wave ray attribute data including travel time data, slowness vector data, energy level data for each seismic source and receiver pair associated with a dataset geometry included in the seismic data.

6. The method of claim 5, wherein the PS-wave ray attribute data are generated by combining:
P-wave ray attribute data derived from P-wave ray tracing between a seismic source and a point scatterer; and
S-wave ray attribute data derived from S-wave ray tracing between the receiver and the point scatterer.

7. The method of claim 6, wherein:
the P-wave ray attribute data and the S-wave ray attribute data, in combination, are applied to generate the dynamic PS-wave ray attribute data; and
the dynamic PS-wave ray attribute data together with geological attribute data related to a ray-based depth migration process are used to generate the PS-wave PSFs.

8. The method of claim 1, wherein one or more of the first reflectivity operator and the second reflectivity operator are derived from elastic properties data of a prior geological model associated with the resource site.

9. The method of claim 1, wherein the report is used for at least one of:
well placement operations at the resource site;
equipment placement operations at the resource site; and
surgically locating a subsurface resource at the resource site.

10. The method of claim 1, wherein the first set of point scatterers associated with the resource site and the second set of point scatterers associated with the resource site are the same set of point scatters associated with the resource site.

11. A system for generating at least one elastic property associated with a geological model, the system comprising:
a computer processor, and
memory storing a data processing engine that includes instructions which are executable by the computer processor to:
receive seismic data captured by one or more sensors associated with a resource site;
extract PP-wave and PS-wave data included in the seismic data;
apply a first imaging process to the extracted PP-wave and PS-wave data and thereby generate PP-wave image angle gathers data and PS-wave image angle gathers data, respectively;
apply a second imaging process to PP-wave demigration data derived from a first set of point scatterers associated with the resource site and thereby generate PP- wave point spread function (PSF) angle gathers that are useable as a first convolution input;
apply a third imaging process to PS-wave demigration data derived from a second set of point scatterers associated with the resource site and thereby generate PS-wave point spread function (PSF) angle gathers that are useable as a second convolution input;
convolve the first convolution input with a first reflectivity operator and thereby generate PP-wave synthetic angle gathers data;
convolve the second convolution input with a second reflectivity operator and thereby generate PS-wave synthetic angle gathers data;
compare the PP-wave image angle gathers data with the PP-wave synthetic angle gathers data and thereby generate first output data;
compare the PS-wave image angle gathers data with the PS-wave synthetic angle gathers data and thereby generate second output data;
combine one or more of the first output data and the second output data with at least one parameter associated with a geological model of the resource site and thereby generate optimization data;
update, based on the optimization data, at least one elastic property associated with the geological model of the resource site;
determine steady state or final values of the at least one elastic property associated with the geological model of the resource site; and
generate a report indicating the steady state or final values of the at least one elastic property on a graphical display device.

12. The system of claim 11, wherein the first imaging process or the second imaging process includes a ray-based depth migration process.

13. The system of claim 11, wherein at least the first imaging process includes creating seismic images collected by a reflection angle at a point of reflection of a propagated seismic wavefield associated with the seismic data.

14. The system of claim 11, wherein:
convolving the first convolution input with the first reflectivity operator and thereby generate PP-wave synthetic angle gathers data includes executing a 3-dimensional spatial convolution operation; and
convolving the second convolution input with the second reflectivity operator and thereby generate PS-wave synthetic angle gathers data includes executing a 3-dimensional spatial convolution operation.

15. The system of claim 11, wherein PS-wave PSFs are generated by computing kinematic or dynamic PS-wave ray attribute data including travel time data, slowness vector data, energy level data for each seismic source and receiver pair associated with a dataset geometry included in the seismic data.

16. The system of claim 11, wherein one or more of the first reflectivity operator and the second reflectivity operator are derived from elastic properties data of a prior geological model associated with the resource site.

17. The system of claim 11, wherein the report is used for at least one of:
well placement operations at the resource site;
equipment placement operations at the resource site; and
surgically locating a subsurface resource at the resource site.

18. A computer program for generating at least one elastic property associated with a geological model, the computer program comprising a non-transitory computer-readable medium comprising code configured to:
receive seismic data captured by one or more sensors associated with a resource site;
extract PP-wave and PS-wave data included in the seismic data;
apply a first imaging process to the extracted PP-wave and PS-wave data and thereby generate PP-wave image angle gathers data and PS-wave image angle gathers data, respectively;
apply a second imaging process to PP-wave demigration data derived from a first set of point scatterers associated with the resource site and thereby generate PP-wave point spread function (PSF) angle gathers that are useable as a first convolution input;
apply a third imaging process to PS-wave demigration data derived from a second set of point scatterers associated with the resource site and thereby generate PS-wave point spread function (PSF) angle gathers that are useable as a second convolution input;
convolve the first convolution input with a first reflectivity operator and thereby generate PP-wave synthetic angle gathers data;
convolve the second convolution input with a second reflectivity operator and thereby generate PS-wave synthetic angle gathers data;
compare the PP-wave image angle gathers data with the PP-wave synthetic angle gathers data and thereby generate first output data;
compare the PS-wave image angle gathers data with the PS-wave synthetic angle gathers data and thereby generate second output data;
combine one or more of the first output data and the second output data with at least one parameter associated with a geological model of the resource site and thereby generate optimization data;
update, based on the optimization data, at least one elastic property associated with the geological model of the resource site;
determine steady state or final values of the at least one elastic property associated with the geological model of the resource site; and
generate a report indicating the steady state or final values of the at least one elastic property on a graphical display device.

19. The computer program of claim 18, wherein the first imaging process or the second imaging process includes a ray-based depth migration process.

20. The computer program of claim 18, wherein:
the report includes one or more of a multi-dimensional visualization including image or textual data associated with the geological model;
the report is adapted for use in energy development operations including at least one of:
well placement operations at the resource site;
equipment placement operations at the resource site;
surgically locating a subsurface resource at the resource site;
carbon storage operations at the resource site;
configuring at least one equipment associated with the energy development operations at the resource site; and
implementing safety protocols associated with the energy development operations at the resource site.
